(19) United States
(12) Patent Application Publication
(10) Pub. No.: US 2025/0252335 A1
(43) Pub. Date: Aug. 7, 2025

(54) QUANTUM COMPUTING APPROACHES FOR RESOURCE ALLOCATION

(71) Applicant: PwC Product Sales LLC, New York, NY (US)

(72) Inventors: Saurabh Sunil CHOUDHARY, Bhandara (IN); Arit Kumar BISHWAS, San Francisco, CA (US); Bibhash MITRA, Burdwan (IN)

(73) Assignee: PwC Product Sales LLC, New York, NY (US)

(21) Appl. No.: 18/431,481

(22) Filed: Feb. 2, 2024

(51) Int. Cl. G06N 10/60

(52) U.S. Cl. CPC G06N 10/60

(57) ABSTRACT

Category data associated with a plurality of categories and resource data associated with a plurality of resources may be received. The category data may indicate, for each category, an amount of resources required by the category. The resource data may indicate, for each resource, a ranking of the plurality of categories. Based on the category data and the resource data, values of one or more constraints associated with an objective function may be generated. The objective function may be configured to characterize, for a given allotment of the plurality of resources to the plurality of categories, an efficiency of the allotment and an alignment of the allotment with the rankings of the plurality of categories. Using a quantum computing system, resource allotment data can be generated. The resource allotment data may indicate an allocation of one or more resources to one or more categories.

### FIELD

The present disclosure relates generally to quantum computing techniques for allocating or dividing resources among groups.

### BACKGROUND

Optimization problems involving the allocation of resources to users of said resources can be found in numerous fields. For example, when managing a set of computational tasks to be executed, computational resources (e.g., computer hardware or computer memory) may need to be allocated to each computational task to ensure that said tasks are executed efficiently. However, in many situations, dividing a set of resources evenly amongst a set of categories may not adequately address the needs of each resource consumer. The problem is further complicated if there are differences in the properties of the resources available for allocation. In particular, a resource that is well-suited for use by a certain user category may be poorly suited for use by another user category.

### SUMMARY

While optimization problems involving allocating resources among consumer categories are prevalent in numerous fields, solving such problems is computationally challenging. Classical computers can take almost a minute to allocate even a relatively small number of resources (e.g., around 100) to a relatively small number of categories (e.g., around 5-10), particularly if both the resource needs of each consumer category and the suitability of each resource to each consumer category are taken into consideration. As the scale of a problem increase—for instance, as the number of resources grows—the run time required for a classical computer to generate an effective solution may increase significantly. The computational challenges associated with generating a solution may, in many cases, limit the quality of said solution, as non-optimal solutions may need to be used in order to conserve the excessive computing resources that would be required to compute optimal solutions using known computational techniques. Thus, identifying solutions that are more highly-optimized may be impractical using known techniques, even when the existence of more optimal solutions is suspected or known. Thus, there is a need for improved systems, methods, and techniques for allocating resources amongst a group of consumer categories in a computationally efficient and effective manner.

Accordingly, disclosed herein are systems and methods for utilizing quantum computing to allocate resources among a group of consumer categories. Quantum computers are capable of solving computationally complex (e.g., NP-hard) problems at higher speeds than classical computers. By harnessing the advantages in computing ability provided by quantum computers, the techniques provided herein enable resource allotments to be generated with higher efficiency than that which is possible with exclusively classical computational processes.

The described systems and methods may produce resource allotments by configuring a quantum computing system (for example, a quantum annealer) to extremize an objective function that characterizes a resource allotment quality level. This quality level may depend on the relative suitability of each resource for use by each category. The objective function may be configured automatically by a classical computing system into which information associated with the resources and the categories has been input. After resource allotment is produced by the quantum computing system, information associated with the resource allotment may be returned from the quantum computing system to the classical computing system, which may then execute a set of automated actions according to the generated allotment.

A method provided herein may include receiving category data associated with a plurality of categories and resource data associated with a plurality of resources. The category data may indicate, for each category of the plurality of categories, an amount of resources required by the category, and the resource data may indicate, for each resource of the plurality of resources, a ranking of the plurality of categories. Based on the category data and the resource data, values of one or more constraints associated with an objective function may be generated. The objective function may be configured to characterize, for a given allotment of the plurality of resources to the plurality of categories, an efficiency of the allotment and an alignment of the allotment with the rankings of the plurality of categories. Using a quantum computing system, based on the objective function and the values of the one or more constraints, resource allotment data may be generated. The resource allotment data may indicate an allocation of one or more resources of the plurality of resources to one or more categories of the plurality of categories.

The quantum computing system may be a quantum annealer. Generating the resource allotment data may comprise solving a constrained quadradic model (QCM) problem or minimizing an output value of the objective function. The one or more constraints associated with the objective function may comprise constraints indicating a minimum number of resources of the plurality of resources that should be allocated to each category of the plurality of categories. The values of the constraints indicating a minimum number of resources of the plurality of resources that should be allocated to each category of the plurality of categories may be set based on the amount of resources required by each category of the plurality of categories. The one or more constraints associated with the objective function comprise constraints may indicate a maximum number of categories of the plurality of categories to which each resource of the plurality of resources should be allocated. In some examples of the method, a graphical representation of the allocation of the one or more resources is generated. The method can further comprise automatically, using a classical computing system, updating one or more databases according to the resource allotment data, as well as validating the allocation of the one or more resources based on the resource allocation data, the amounts of resources required by each category, and the rankings of the plurality of categories associated with each resource.

In some embodiments, the plurality of categories is a plurality of business units, the plurality of resources is a plurality of employees, and the ranking of business units associated with each employee indicates the employee's preference for working in each business unit. The method may include automatically generating and deploying one or more communicative channels for one or more employee devices based on the resource allotment data. In other embodiments, the plurality of categories is a plurality of computational tasks, the plurality of resources is a plurality of computational resources, and the ranking of computational tasks associated with each computational resource indicates an efficiency with which the computational resource could execute each computational task. The method may include automatically provisioning one or more of the plurality of computational resources based on the resource allotment data. In other embodiments, the plurality of categories is a plurality of land uses, the plurality of resources is a plurality of land plots, and the ranking of land uses associated with each land plot indicates a level of approval for using the land plot for each land use.

A system provided herein may include a classical computing system and a quantum computing system. The system may be configured to receive category data associated with a plurality of categories and resource data associated with a plurality of resources, wherein the category data indicates, for each category of the plurality of categories, an amount of resources required by the category, and the resource data indicates, for each resource of the plurality of resources, a ranking of the plurality of categories. The system may be further configured to generate, based on the category data and the resource data, values of one or more constraints associated with an objective function configured to characterize, for a given allotment of the plurality of resources to the plurality of categories, an efficiency of the allotment and an alignment of the allotment with the rankings of the plurality of categories and, using the quantum computing system, based on the objective function and the values of the one or more constraints, resource allotment data, wherein the resource allotment data indicates an allocation of one or more resources of the plurality of resources to one or more categories of the plurality of categories.

The quantum computing system can be a quantum annealer. The quantum computing system may generate the resource allotment data by solving a constrained quadratic method (QCM) problem or by minimizing an output value of the objective function. The one or more constraints associated with the objective function may comprise constraints indicating a minimum number of resources of the plurality of resources that should be allocated to each category of the plurality of categories. The values of the constraints indicating a minimum number of resources of the plurality of resources that should be allocated to each category of the plurality of categories may be set based on the amount of resources required by each category of the plurality of categories. The one or more constraints associated with the objective function can comprise constraints indicating a maximum number of categories of the plurality of categories to which each resource of the plurality of resources should be allocated.

The classical computing system may include a user interface, and the classical computing system can be configured to generate and display, using the user interface, a graphical representation of the allocation of the one or more resources. The classical computing system may be configured to automatically update one or more databases according to the resource allotment data.

In some embodiments, the plurality of categories is a plurality of business units, the plurality of resources is a plurality of employees, and the ranking of business units associated with each employee indicates the employee's preference for working in each business unit. In other embodiments, the plurality of categories is a plurality of computational tasks, the plurality of resources is a plurality of computational resources, and the ranking of computational tasks associated with each computational resource indicates an efficiency with which the computational resource could execute each computational task. In other embodiments, the plurality of categories is a plurality of land uses, the plurality of resources is a plurality of land plots, and the ranking of land uses associated with each land plot indicates a level of approval for using the land plot for each land use.

A non-transitory computer readable storage medium is also provided. The non-transitory computer readable storage medium may store instructions that, when executed by one or more processors of a classical computing system, cause the classical computing system to: receive category data associated with a plurality of categories and resource data associated with a plurality of resources, wherein the category data indicates, for each category of the plurality of categories, an amount of resources required by the category, and the resource data indicates, for each resource of the plurality of resources, a ranking of the plurality of categories, generate, based on the category data and the resource data, values of one or more constraints associated with an objective function configured to characterize, for a given allotment of the plurality of resources to the plurality of categories, an efficiency of the allotment and an alignment of the allotment with the rankings of the plurality of categories, and receive, from a quantum computing system, resource allotment data generated by the quantum computing system based on the objective function and the values of the one or more constraints, wherein the resource allotment data indicates an allocation of one or more resources of the plurality of resources to one or more categories of the plurality of categories.

### BRIEF DESCRIPTION OF THE FIGURES

The following figures show various systems and methods for allocating resources to various categories using quantum computing, according to some embodiments. The systems and methods shown in the figures may have any one or more of the characteristics described herein.

FIG. 1A shows a block diagram of a resource allocation system, according to some embodiments.

FIG. 1B shows a block diagram of a classical computing system, according to some embodiments.

FIG. 1C shows a block diagram of a quantum computing system, according to some embodiments.

FIG. 2A shows a graphical representation of a plurality of categories to which resources can be allocated, according to some embodiments.

FIG. 2B shows a graphical representation of a plurality of resources to be allocated to one or more categories, according to some embodiments.

FIG. 2C shows a graphical representation of a resource allotment, according to some embodiments.

FIG. 3 shows a method for allocating resources, according to some embodiments.

FIG. 4A shows a graphical representation of a method for determining a resource allotment using quantum annealing, according to some embodiments.

FIG. 4B shows a method for determining a resource allotment using quantum annealing, according to some embodiments.

FIG. 5A shows data comparing total amounts of time required by a classical computing system to allocate resources to categories and total amounts of time required by the classical-quantum hybrid system described herein to allocate resources to categories.

FIG. 5B shows data comparing the quality of resource allocations produced by a classical computing system and the quality of resource allocations produced by the classical-quantum hybrid system described herein.

### DETAILED DESCRIPTION

As described, optimization problems that involve determining how a set of resources should be distributed among a set of resource consumers are widespread. Regardless of context, problems of this type may have the following structure: a set of resources must be allocated among a set of categories (e.g., consumers of the resources) such that each category receives its required amount of resources and such that each resource is used effectively.

Solving problems of this form is computationally challenging. Classical computing algorithms may require several minutes to generate a solution to a problem that satisfies the problem's constraints. The provided systems and methods address these challenges by harnessing the computational capabilities of quantum computing systems. Quantum computers can provide fast and accurate solutions to computationally complex (e.g., NP-hard) optimization problems such as constrained quadratic model (CQM) problems and quadratic unconstrained binary optimization (QUBO) problems. The advantages in computing ability provided by quantum computers may allow high quality resource allotments to be efficiently generated, even for large-scale problems.

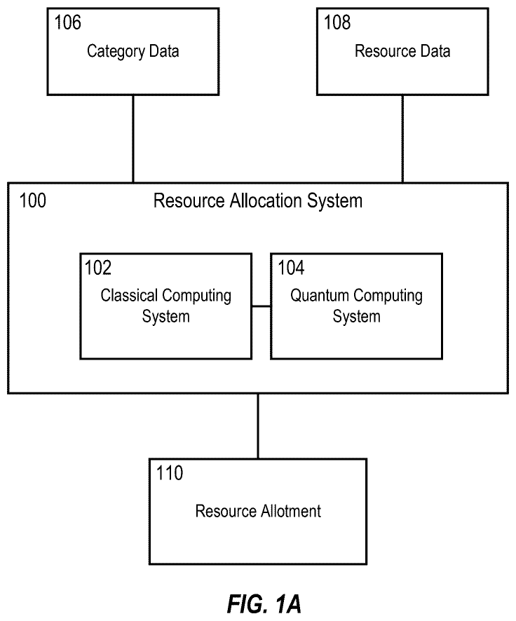

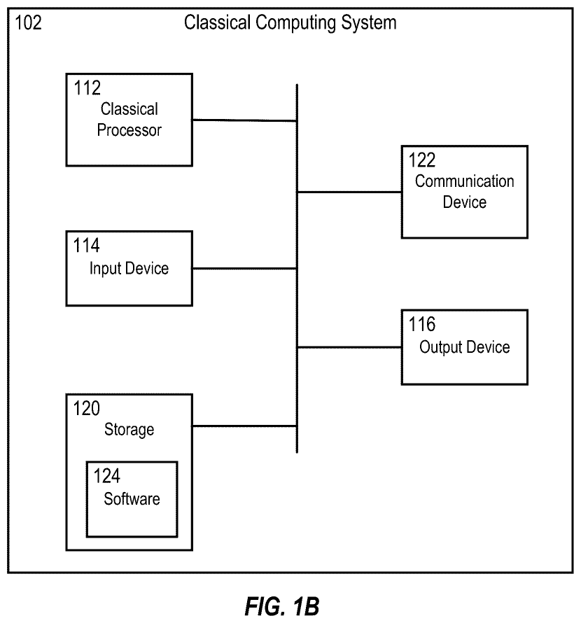

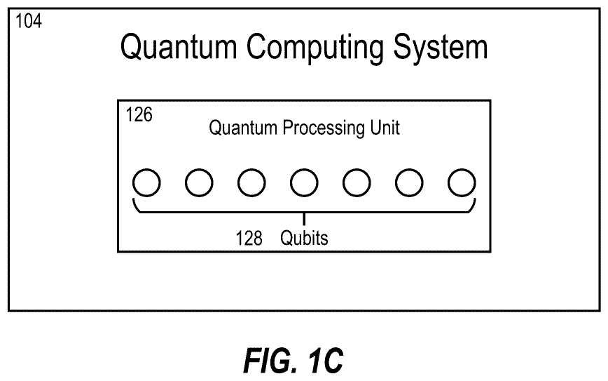

FIG. 1A depicts a block diagram of an exemplary resource allocation system 100. As shown, system 100 may include a classical computing system 102 and a quantum computing system 104. System 100 may be configured to ingest category data 106 associated with a plurality of categories to which resources can be allocated as well as resource information 108 associated with a plurality of resources that can be allocated to the categories. Based on this information, system 100 may use classical computing system 102 and quantum computing system 104 to generate a resource allotment 110 that allocates one or more resources indicated in resource information 108 to one or more categories indicated in category data 106.

Classical computing system 102 can be any suitable type of microprocessor-based device, such as a personal computer, workstation, server, or handheld computing device (portable electronic device) such as a phone or tablet, or dedicated device. As shown in FIG. 1B, classical computing system 102 may include one or more classical (binary) processors 112, an input device 114, an output device 116, storage 120, and a communication device 122.

Input device 114 and output device 116 can be connectable or integrated with system 102. Input device 114 may be any suitable device that provides input, such as a touch screen, keyboard or keypad, mouse, or voice-recognition device. Likewise, output device 116 can be any suitable device that provides output, such as a display, touch screen, haptics device, or speaker.

Storage 120 can be any suitable device that provides (classical) storage, such as an electrical, magnetic, or optical memory, including a RAM, cache, hard drive, removable storage disk, or other non-transitory computer readable medium. Communication device 122 can include any suitable device capable of transmitting and receiving signals over a network, such as a network interface chip or device. The components of classical computing system 102 can be connected in any suitable manner, such as via a physical bus or via a wireless network.

Processor(s) 112 may be or comprise any suitable classical processor or combination of classical processors, including any of, or any combination of, a central processing unit (CPU), a field programmable gate array (FPGA), and an application-specific integrated circuit (ASIC). Software 124, which can be stored in storage 120 and executed by processor(s) 112, can include, for example, the programming that embodies the functionality of the present disclosure. Software 124 may be stored and/or transported within any non-transitory computer-readable storage medium for use by or in connection with an instruction execution system, apparatus, or device that can fetch instructions associated with the software from the instruction execution system, apparatus, or device and execute the instructions. In the context of this disclosure, a computer-readable storage medium can be any medium, such as storage 120, that can contain or store programming for use by or in connection with an instruction execution system, apparatus, or device.

Software 124 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Classical computing system 102 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Classical computing system 102 can implement any operating system suitable for operating on the network. Software 124 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Classical computing system 102 may be communicatively coupled to quantum computing system 104. Quantum computing system 104 may be any suitable quantum-processor-based device. In other words, as illustrated in FIG. 1C, quantum computing system 104 may be any device comprising a quantum processing unit (QPU) 126 configured to perform computational operations by encoding information in and manipulating the quantum states of one or more qubits 128. In some embodiments, quantum computing system 104 may be or may comprise a specific class of quantum computer such as, e.g., a quantum annealer.

Each qubit 128 may be a two-state quantum mechanical system. Possible implementations of qubits 128 can include, in non-limiting examples, electrons (e.g., electron spin qubits), photons (e.g., polarization encoding or time bin encoding qubits), atomic nuclei (e.g., nuclear spin encoded qubits), quantum dots, Josephson junctions (e.g., flux qubits), and solid-state defects (e.g., nitrogen vacancy centers in diamond).

To facilitate the encoding and manipulation of information, quantum computing system 104 may include devices such as lasers, microwave radiation sources, voltage sources, current sources, digital-to-analog converters, application specific integrated circuits (ASICs), and field programmable gate arrays (FPGAs). Additionally, quantum computing system 104 may include any environmental control components necessary to stabilize qubits 128. For example, quantum computing system 104 may include apparatuses configured to control the temperature of qubits 128. Quantum computing system 104 can also include one or more classical computing devices (e.g., CPUs or GPUs) configured to interface with QPU 126 to (for example) compile instructions for a given quantum algorithm to be executed by the quantum computing system 104 or process quantum-state measurements after the quantum algorithm is executed. In some embodiments, quantum computing system 104 shares one or more components with classical computing system 102.

Category data 106 may be received by classical computing system 102 and may comprise information indicating a total number of categories to which resources can be allocated as well as various metadata associated with or describing each category. Category data 106 may be input into classical computing system 102 by one or more users (e.g., via a user interface) or may be automatically downloaded from one or more information sources (e.g., one or more databases storing data associated with the categories). In some embodiments, at least a portion of information contained in category data 106 may be programmatically determined by classical computing system 102 and/or by an associated computing system based on one or more predefined rules or algorithms.

The categories indicated by category data 106 may vary based on problem context. In some embodiments, the categories are teams or groups of people, for example teams within a business or a company, teams within an athletic club or conference, or sections of a class at a school. In other embodiments, the categories are entities that consume a resource, for example computational tasks that consume computational resources, storage tasks that consume computer storage resources, battery charging tasks that take up battery charging hardware or battery charging infrastructure, or land uses that consume land resources (e.g., land uses that take up certain amounts of land area). Any number of distinct categories may be described by category data 106. For example, category data 106 may indicate at least 2, at least 3, at least 4, at least 5, at least 10, at least 20, at least 30, at least 40, at least 50, at least 100, or at least 500 distinct categories.

Resource data 108 may also be received by classical computing system 102. Resource data 108 may indicate a total number of resources available to be allocated to the categories described by category data 106 as well as various metadata associated with or characterizing each resource. One or more users may input resource data 108 into classical computing system 102 (e.g., using a user interface); resource data 108 may also be downloaded automatically from one or more information sources (e.g., one or more databases storing data associated with the resources). In some embodiments, at least a portion of resource data 108 may be programmatically determined by classical computing system 102 and/or by an associated computing system based on one or more predefined rules or algorithms.

Like the categories, the resources may vary based on problem context. Specifically, the resources may depend on the categories themselves. If, for example, the categories are teams or groups of people, the resources may comprise individuals (e.g., workers, athletes, students, etc.) who are available to join said teams or groups. Alternatively, if the categories are, for example, computational tasks, the resources may be computational resources (e.g., computer hardware or software). If the categories are land uses, the resources may comprise plots of land available for use. If the categories are battery charging tasks, then the resources may be battery charging hardware or components of battery charging infrastructure (e.g., chargers for personal electronic devices such as laptop computers or phones, chargers for car batteries, etc.). In some embodiments, the total number of resources exceeds the total number of categories. In other embodiments, the total number of resources is less than or equal to the total number of categories.

Each category may require a certain amount (e.g., number, proportion, etc.) of the available resources. For example, if the categories are teams within a company, then each team may require a minimum number of workers in order to properly function. If the categories are computational tasks, then each computational task may require a minimum amount of computational resources. If the categories are land uses, then each land use may require a minimum land area. The resource requirements of each category may be included in or derived based on category data 106.

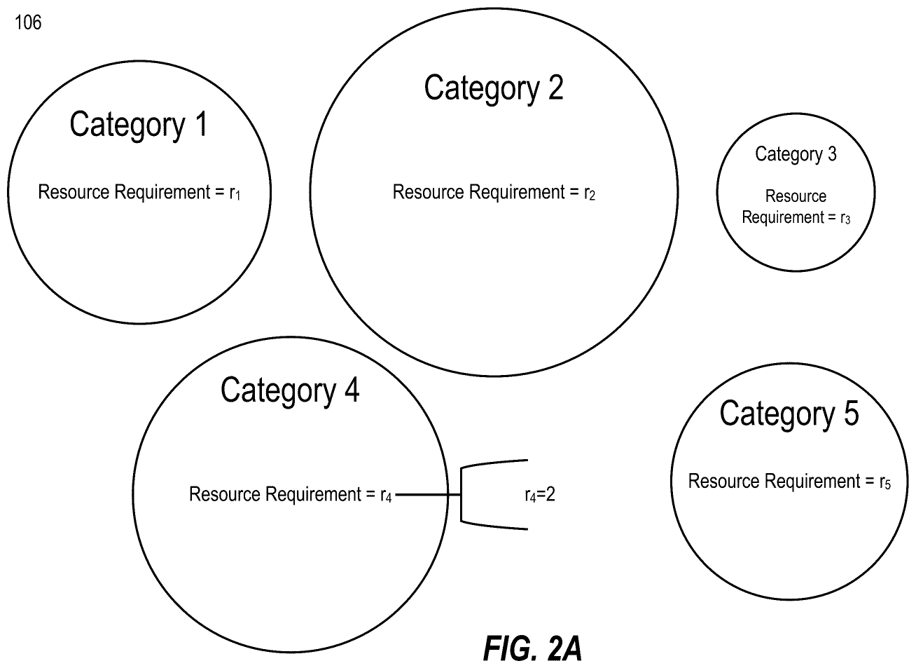

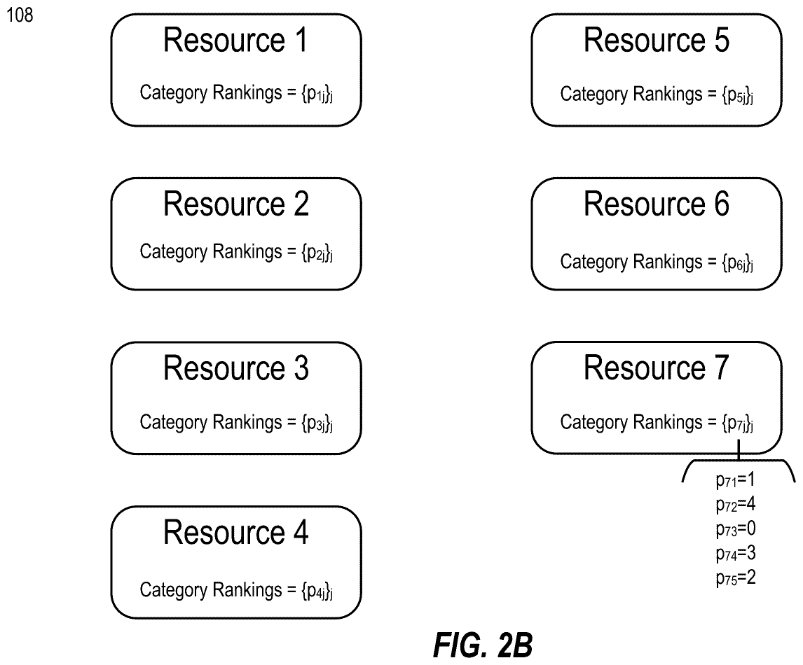

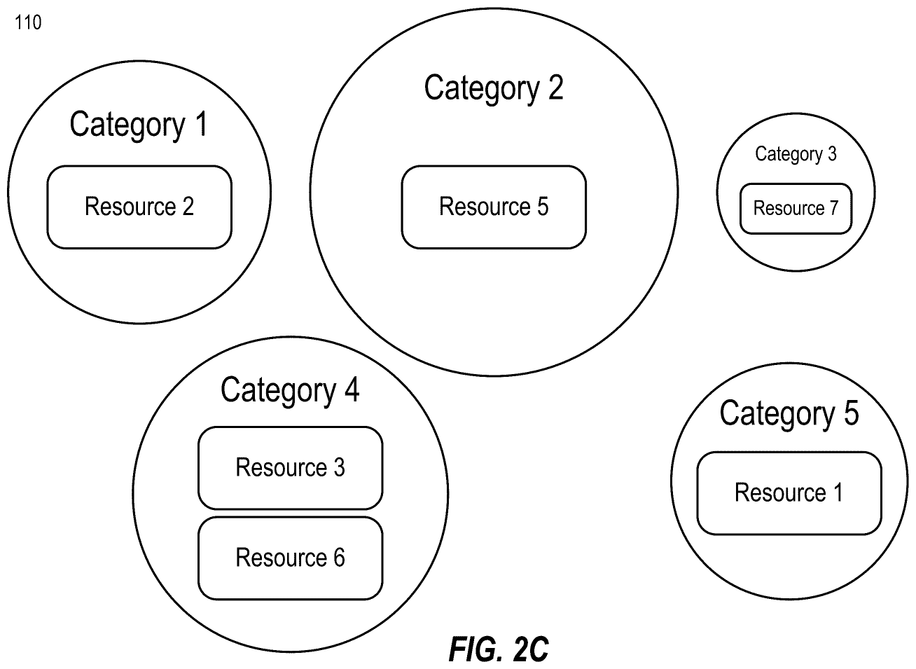

FIG. 2A provides a graphical representation of example category data 106. In this example, category data 106 indicates five distinct categories: Category 1, Category 2, Category 3, Category 4, and Category 5. Each of the five categories has an associated resource requirement that quantifies a minimum amount of resources that should be allocated to the category. Specifically, Category 1 requires an amount r₁ of resources, Category 2 requires an amount r₂ of resources, Category 3 requires an amount r₃ of resources, Category 4 requires an amount r₄ of resources, and Category 5 requires an amount r₅ of resources. r₁-r₅ may be numbers greater than zero and may, depending on the resources being allocated, be integers or real numbers. For example, as shown in FIG. 2A, the resource requirement of Category 4 may be r₄=2.

Each resource may be better suited to (e.g., may be more efficiently and/or more effectively used by) certain categories over others. For example, different computational resources may execute certain computational tasks more efficiently than others (e.g., a GPU may execute parallelizable tasks more efficiently than a CPU). Similarly, different individuals may prefer to be assigned to certain teams/groups over other teams/groups based on, e.g., their personal interests or their personal skillset. Resource data 108 may indicate, for each resource, an affinity or suitability of the resource for allocation to each category by providing, for each available resource, a ranking of the plurality of categories according to how well suited the resource is to be allocated to each category. The ranking may assign a numerical value to each category that corresponds to the affinity or suitability of the resource for allocation to the category. In some embodiments, the numerical value is an integer between zero and N, where N is the total number of available categories.

A graphical representation of example resource data 108 is provided in FIG. 2B. In this example, resource data 108 indicates seven distinct resources that are available for allocation: Resource 1, Resource 2, Resource 3, Resource 4, Resource 5, Resource 6, and Resource 7. Associated with each resource i is a category ranking {pᵢⱼ}>, which may be a list of j numbers corresponding to the j categories to which each resource can be allocated. A number pᵢⱼ in the list may indicate the relative suitability of resource i to allocation to category j. If, for instance, there are five available categories (e.g., as shown in FIG. 2A), the category ranking {pᵢⱼ}ⱼ associated with resource i may be a list of five numbers corresponding to the five categories. For example, the category ranking {p₇ⱼ}ⱼ associated with Resource 7 may be the list {p₇₁, p₇₂, p₇₃, p₇₄, p₇₅}, where p₇₁ is a number representing the suitability of Resource 7 to allocation to Category 1 relative to Categories 2-5, p₇₂ is a number representing the suitability of Resource 7 to allocation to Category 2 relative to Category 1 and Categories 3-5, and so on. Example values for each entry p₇ⱼ in the category ranking {p₇}ⱼ associated with Resource 7 are provided in FIG. 2B; these values may indicate that Resource 7 is best suited to be allocated to Category 3 (p₇₃=0) and is worst suited to be allocated to Category 2 (p₇₂=4).

Resource allotment 110 may ensure that the resource requirements of each category are satisfied while maximizing the number of resources that are allocated to categories to which they are best suited. A graphical representation of an example allotment 110 of the resources depicted in FIG. 2B to the categories depicted in FIG. 2A is provided in FIG. 2C. In this allotment, Resource 2 is allocated to Category 1, Resource 5 is allocated to Category 2, Resource 7 is allocated to Category 3, Resources 3 and 6 are allocated to Category 4, and Resource 1 is allocated to Category 5. As shown, allotment 110 satisfies the resource requirement r₄=2 of Category 4 (see FIG. 2A) and allocates Resource 7 to the category to which it is best suited (Category 3; see FIG. 2B).

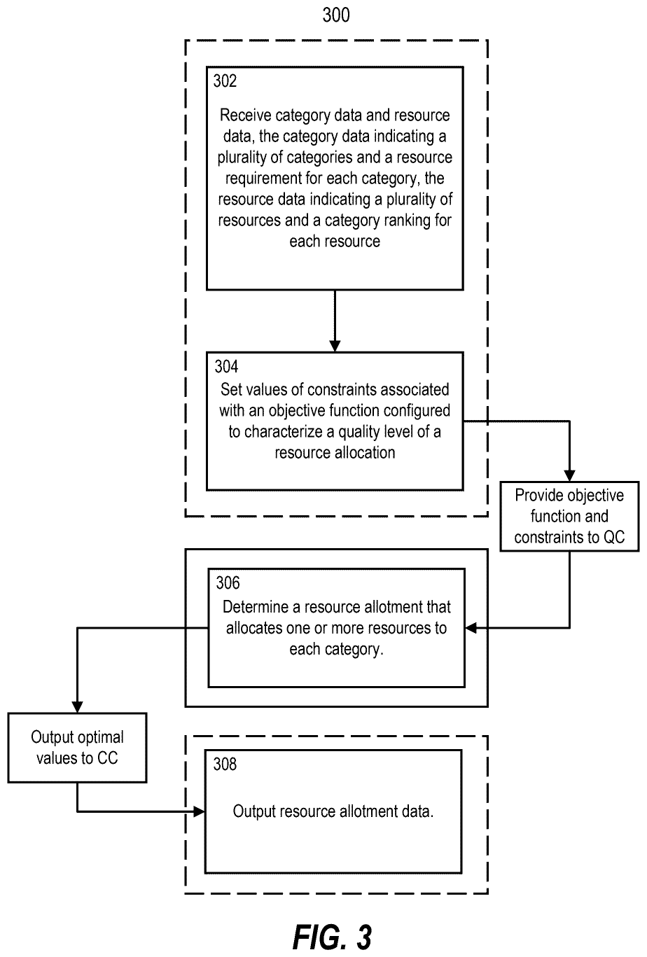

FIG. 3 shows an exemplary method 300 for allocating resources to categories. Method 300 may be executed by a system (e.g., system 100 shown in FIG. 1A) comprising a classical computing system (e.g., classical computing system 102 shown in FIGS. 1A-1B) and a quantum computing system (e.g., quantum computing system 104 shown in FIGS. 1A and 1C). In some embodiments, method 300 is initiated by a user, or is performed automatically on a regular, pre-scheduled basis (e.g., once per week, once per month, once per year, etc.). Method 300 may also be initiated by the detection or predicted occurrence of certain events, for example a change in the resource requirements of one or more categories, a change in the number of categories, or a change in the amount or number of resources available for allocation.

Method 300 may begin with the receipt of category data (e.g., category data 106 shown in FIG. 1A) and resource data (e.g., resource data 108 shown in FIG. 1A) by the classical computing system (step 302). As previously noted, the category data may indicate a plurality of categories as well as an amount of resources required by each category. The resource data may indicate a plurality of resources. A ranking of the plurality of categories may be associated with each resource of the plurality of resources. The classical computing system may receive this information directly from a user (e.g., via a user interface), automatically from various information sources (e.g., from databases storing information about the plurality of categories or the plurality of resources), or from combinations thereof. In some embodiments, portions of the category data (e.g., the resource requirements of each category) or portions of the resource data (e.g., the category rankings associated with each resource) may be determined programmatically by the classical computing system based on one or more predefined rules or algorithms.

After the category and resource data is received by the classical computing system, the values of one or more constraints associated with an objective function may be set (step 304). The objective function may characterize, for a given allotment of the plurality of resources to the plurality of categories, an efficiency of the allotment and an alignment of the allotment with the rankings of the plurality of categories associated with each resource. The efficiency of the allotment may depend on the number of categories that receive their required number of resources. The alignment of the allotment with the category rankings may depend on the extent to which the resources are allocated to categories to which they are well suited. The objective function may be configured such that the resource allotment that extremizes (e.g., maximizes or minimizes) the objective function is a resource allotment that aligns as closely as possible with the category rankings associated with each resource. In some embodiments, a resource allotment that extremizes the objective function may be an allotment in which a majority of the resources are allocated to categories to which they are well suited. The objective function may be stored in the memory of the classical computing system.

The objective function may depend on the categories to which each resource is allocated as well as the rankings of each category by each resource. An example objective function is provided in Equation 1:

$${f}_{obj} = {\sum }_{i , j} {x}_{ij} {p}_{ij} \qquad ( 1 )$$

In Equation 1, summation index i counts the available resources and summation index j counts the available categories. xᵢⱼ may be a number that indicates whether resource i is allocated to category j in a given resource allotment. In some embodiments,

$${x}_{ij} = \{ \begin{matrix}1 , if resource i is allocated to category j \\ 0 , if resource i is not allocated to category j\end{matrix} \qquad ( 2 )$$

pᵢⱼ may be the ranking, relative to the other categories, of category j by resource i. In some embodiments, pᵢⱼ is an integer between zero and N, where N is the total number of categories. If pᵢⱼ is closer to one, then resource i may be relatively well-suited to allocation to category j. On the other hand, if pᵢⱼ is closer to N, then resource i may not be well-suited to allocation to category j.

The constraints associated with the objective function can include constraints on the number of resources that should be allocated to each category. For example, as indicated by Equation 3, the constraints may require that the total number of resources that should be allocated to category j be greater than or equal to the resource requirement rⱼ of category j:

$${\sum }_{i} {x}_{ij} \geq {r}_{j} \qquad ( 3 )$$

The value xᵢⱼ in Equation 3 is defined by Equation 2. The constraints associated with the objective function can also include constraints on the maximum number of categories to which each resource can be allocated, as shown in Equation 4:

$${\sum }_{j} {x}_{ij} = α \qquad ( 4 )$$

Equation 4 states that the total number of categories to which a resource i can be assigned is α. The value xᵢⱼ in Equation 4 is defined by Equation 2. α may be a non-negative integer (i.e., an integer greater than or equal to 0). If, for example, α=1, then resource i may be allocated to at most one category. If α=5, then resource i may be split between five different categories. In some embodiments, the value of α varies for each resource; in other embodiments, the value of α is the same for each resource.

The classical computing system may automatically set the values of the constraints based on the category data and the resource data received in step 202. The values of one or more of the constraints can also be manually updated by a user. For example, a user may explicitly define the number of categories to which each resource can be allocated (e.g., may directly input values of a (as defined by Equation 4) for each resource i).

After the values of the constraints associated with the objective function are updated by the classical computing system, the objective function, along with the constraints, may be provided to the quantum computing system, which may then determine a resource allotment (step 306). The quantum computing system may be configured to determine the resource allotment by extremizing (e.g., minimizing or maximizing) the objective function in view of the associated constraints. In some embodiments, the problem of extremizing the objective function is in the NP complexity class and thus may be represented as a constrained quadratic model (CQM) problem or a quadratic unconstrained binary optimization problem (QUBO). The forms of these problems are indicated in Table 1.

TABLE 1
CQM and QUBO problems

| Problem | Objective Function | Constraints |
|---|---|---|
| COM | ${\sum }_{i} {a}_{i} {x}_{i} + {\sum }_{i \leq j} {b}_{ij} {x}_{i} {x}_{j} + c$ | xᵢ is a binary, integer, or real-valued variable; |
| | | aᵢ, bᵢⱼ, and c are real numbers; |
| | | m = 1, ... , M, where M is the total num- |
| | | ber of constraints, and |
| | | ${\sum }_{i} {a}_{i}^{( m )} {x}_{i} + {\sum }_{i \leq j} {b}_{ij}^{( m )} {x}_{i} {x}_{j} + {c}^{( m )} ∘ 0$ |
| | | where ∘ ∈ {≥, ≤, =}. |
| QUBO | ${\sum }_{i \leq j} {x}_{i} {Q}_{i , j} {x}_{j}$ | Q is an upper-diagonal matrix; and xᵢ is a binary variable. |

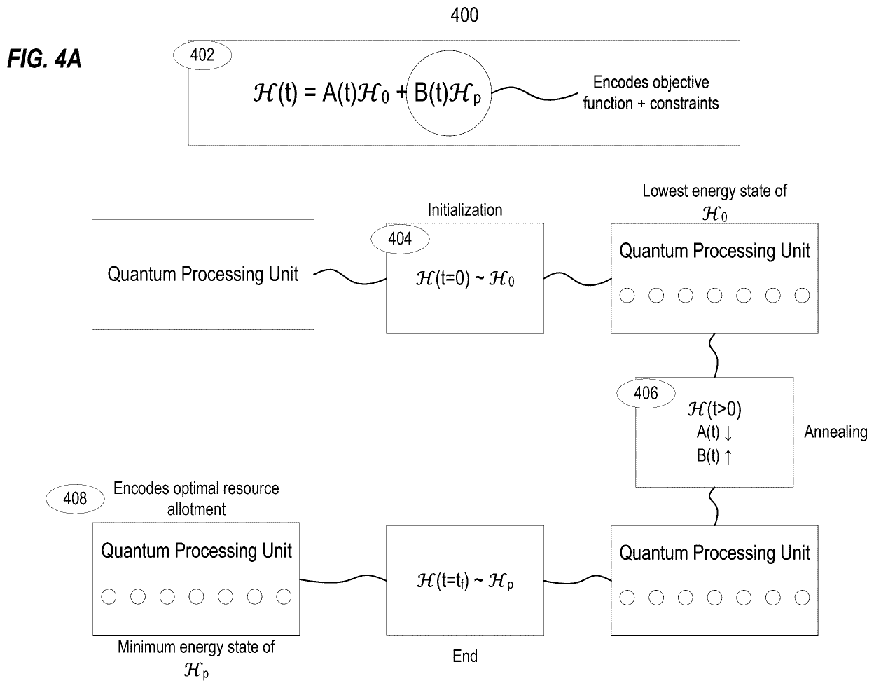

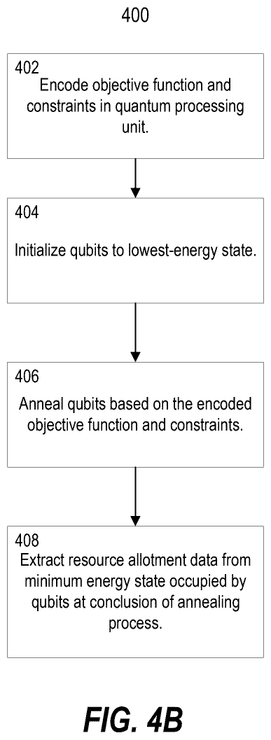

To extremize the objective function, the quantum computing system may execute a quantum optimization process such as quantum annealing. A visual representation of an exemplary quantum annealing process 400 is depicted in FIG. 4A and a corresponding flowchart is provided in FIG. 4B.

To begin the annealing process, the objective function and the associated constraints may be encoded as a time-dependent term ( [symbol] ₚ, sometimes referred to as the “final Hamiltonian” or the “problem Hamiltonian”) in a Hamiltonian operator ( [symbol] (t)) for qubits in the quantum computing system (step 402). The lowest energy state of this “final Hamiltonian” may correspond to the extremized value of the objective function. Encoding the objective function and the associated constraints in the Hamiltonian may require mapping the logical representations of the function and the constraints onto the physical qubit topology of the quantum computer, e.g., using minor-embedding. This mapping process may be performed manually by a user (e.g., via a user interface that enables the user to interact directly with the quantum computing system) or automatically by a classical computing system configured to interface directly with the quantum computer At this stage, annealing parameters such as the total annealing time may also be set, either by a user or automatically.

In addition to the “final Hamiltonian” term, the Hamiltonian operator may include an “initial Hamiltonian” (also known as a “tunnelling Hamiltonian” or “driving Hamiltonian”) term ( [symbol] ₀). As previously noted, each qubit in the quantum computer may be a two-state quantum mechanical system; the ground state of the “initial Hamiltonian” may be a superposition of all states of the qubit system.

The functions A(t) and B(t) may be configured to adjust the weights of the initial Hamiltonian and the final Hamiltonian, respectively, as the annealing process progresses. In other words, A(t) and B(t) may be configured such that, as the annealing process progresses (e.g., as the annealing time parameter t increases from a start time of t=0), the influence of the initial Hamiltonian on the qubits grows weaker and the influence of the final Hamiltonian on the qubits grows stronger, thereby causing the states of qubits to evolve toward the lowest energy state of the final Hamiltonian. In other words, at the start of the annealing process (t˜0), A(t)>>B(t) and, as a result, [symbol] (t)˜ [symbol] ₀.

After the objective function and the associated constraints are encoded in the final Hamiltonian, the qubit system may be initialized to the lowest energy state of [symbol] ₀ (step 404). As the annealing process progresses and the time parameter increases (t>0), the magnitude of A(t) relative to the magnitude of B(t) may decrease, reducing the influence of the initial Hamiltonian and increasing the influence of the final Hamiltonian on the qubits (step 406). The quantum computing system may be configured to execute this process slowly and to minimize interference by energy sources external to the quantum computing system (e.g., to execute the process as close to adiabatically as possible). By the end of the annealing process (t˜t_{f}, where t_{f} is the total annealing time), A(t)<<B(t) and [symbol] (t)˜ [symbol] ₚ. As a result, at the end of the annealing process, the qubits may occupy the lowest energy state of [symbol] ₚ. From this state, data indicating the resource allotment that extremizes the objective function may be extracted (step 408).

Once the data indicating the resource allotment is determined using the quantum computing system (step 306 of method 300), data associated with the resource allotment may be output by the classical computing system (step 308 of method 300), for example to one or more users. The resource allotment information may indicate the resources that are assigned to each category. In some embodiments, the classical computing system is configured to generate and display (e.g., using a user interface) a graphical representation of the resource allotment. The resource allotment data may also include a validation of a quality level of the allotment, which may be automatically characterized by the classical computing system based on the category rankings associated with each resource. In some embodiments, the classical computing system validates the quality level of a resource allotment by calculating a quality index value as shown, for example, in Equation 5:

$$Index = \frac{{\sum }_{i , j} {x}_{ij} ( N - {p}_{ij} )}{NM} \qquad ( 5 )$$

In Equation 5, xᵢⱼ is given by Equation 2, N is the total number of categories, pᵢⱼ is the ranking of category j by resource i, and M is the total number of resources. The value of the index may range between 0 and 1; an index value closer to zero may correspond to a low-quality solution, while an index value closer to 1 may correspond with a high-quality solution.

In addition to outputting entity assignment information to assignees, the classical computing system may be configured to automatically execute one or more tasks based on the determined resource allotment. For example, the classical computing system may facilitate the allocation of the resources to the categories according to the resource allotment by automatically updating one or more databases associated with the categories or the resources. Facilitating the allocation of the resources to the categories may involve placing orders that cause the resources to be moved to locations corresponding to the categories to which they are allocated, generating work schedules or office assignments for workers, generating class schedules for students, generating a map indicating how various plots of land will be used, instantiating communicative connections between computational resources and devices associated with computational tasks to be executed, automatically provisioning and utilizing computational resources to execute computational tasks, or automatically disconnecting or connecting battery charging hardware or other battery infrastructure to batteries that require charging or discharging.

### Example 1: Allocating Computational Resources to Computational Tasks

The described systems and methods can be used to allocate computational resources to computational tasks that require execution. Examples of computational tasks include steps or sequences of instructions in a computational process, computational job, or programming thread, data requests, and information queries. Computational resources can include hardware (e.g., specific computational devices), software, computation time, and memory space. Each computational task may require a certain amount of computational resources in order to be completed in a reasonable amount of time. Meanwhile, a given computation resource may execute some types of computational tasks more efficiently than others. For example, a GPU may be better suited than a CPU to execute a highly parallelizable computational task. The provided systems and methods can determine a computational resource allotment which ensures that each task receives its required amount of resources and that the resources are being used as efficiently.

### Example 2: Allocating Individuals to Teams

The described systems and methods can be used to allocate individuals to teams. Example types of individuals include (but are not limited to) employees of a company, athletes who play a sport, or students who need to take a specific class. Likewise, example types of teams include (but are not limited to) business units or divisions within a company, teams in a sport league, or sections of a class.

For various reasons, an individual may prefer certain teams over others. The classical computing system of the resource allocation system (e.g., classical computing system 102 of system 100) may receive a ranking of the teams from each individual that indicates that indicates the individual's relative preference for each team. The classical computing system may also be provided with information indicating a minimum number of individuals required by each team in order for that team to function. The quantum computing system may then be used to determine an allocation of the individuals to the teams that satisfies the membership requirements of each team while maximizing the extent to which the individuals are assigned to their preferred teams.

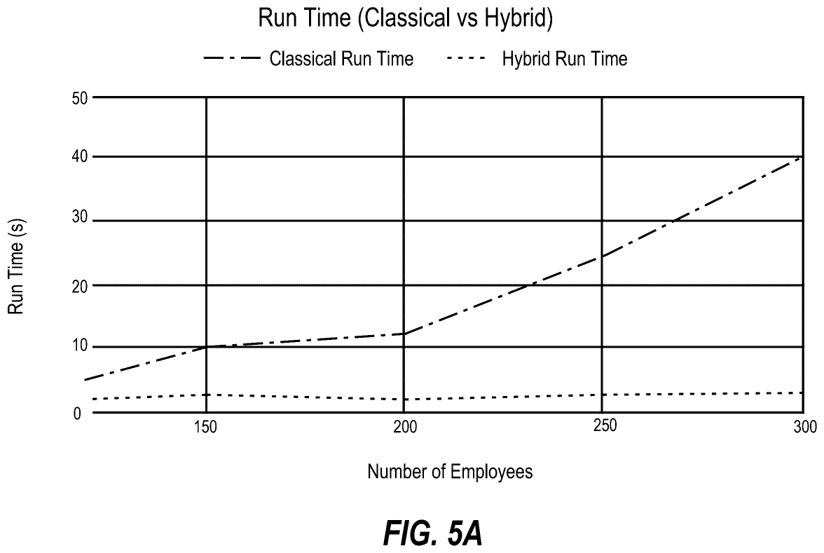

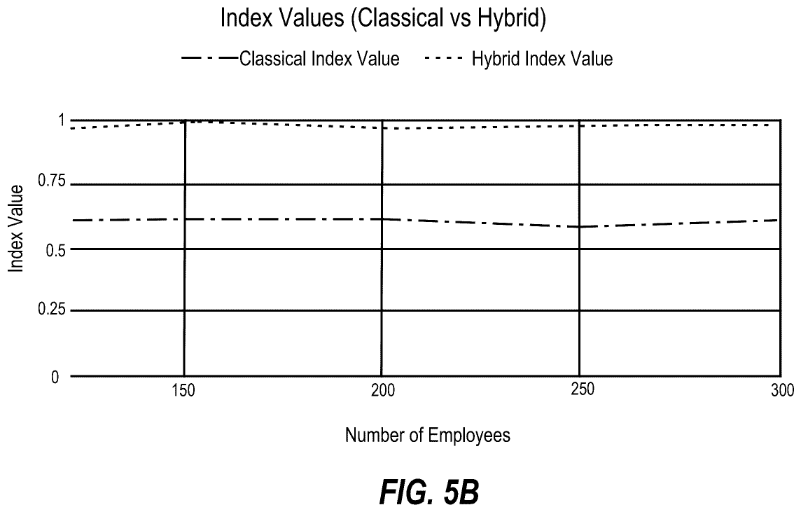

FIG. 5A provides example data comparing the amount of time required by a classical computing system to determine an optimal allotment of employees to business units using solely classical methods (i.e., without the use of quantum computing techniques) to the amount of time required by the disclosed classical-quantum hybrid system to determine an optimal allotment of employees to business units using the described methods. As shown, the run times of the hybrid system are significantly less than the run times of the classical system. Furthermore, the run times of the hybrid system remain effectively constant (under 10 seconds), even as the total number of employees being allocated increases. The run times of the classical system, on the other hand, increase significantly (from approximately 10 seconds to approximately 40 seconds) as the number of employees increases. This data suggests that the provided hybrid system is capable of generating solutions more efficiently than a system that relies exclusively on classical computing techniques.

In addition to the efficiency advantages, the provided hybrid systems may produce higher quality solutions than exclusively classical systems. This is shown in FIG. 5B, which provides data comparing the quality index values (given by Equation 5) of allotments of employees to business units determined by a hybrid system and the quality index values of allotments of employees to business units determined using solely classical methods. The indices of the employee allotments determined using the provided hybrid system are approximately equal to 1, regardless of the number of employees being allocated. That is, the quality of the employee allotments determined using the hybrid system is consistently high. The indices of the employee allotments determined using exclusively classical computing techniques are lower (>0.75) than the indices of the allotments determined using the hybrid system, suggesting that the hybrid solutions are able to assign more employees to their preferred business units while satisfying the employee requirements of each business unit.

### Example 3: Allocating Plots of Land for Land Uses

The provided systems and methods may be used to allocate plots of land (e.g., unused plots of land in a city) for various land uses. Land uses may include residential land uses (e.g., apartment complexes or other housing developments), governmental land uses (e.g., government buildings, public libraries, etc.), industrial land uses (e.g., manufacturing or processing plants), commercial land uses (e.g., stores, shopping malls, restaurants, etc.), recreational land uses (e.g., public parks), and land uses for transportation (e.g., roads, sidewalks, bike lanes, etc.). Each land use may require a certain area of land. However, each plot of land may not be suitable for every possible land use, even if the area of the plot is sufficient. Physical characteristics of a plot of land (e.g., its terrain or its soil composition) may make certain land uses difficult or expensive. Furthermore, public opinion regarding certain uses of a given plot of land may be higher or lower than public opinion regarding other uses. For example, public approval of using a naturally beautiful plot of land for commercial or manufacturing purposes may be lower than public approval for using that same plot of land as a park. The described systems and methods can generate a land allotment that ensures each land use is allocated its required amount of land while simultaneously ensuring that the benefits of each plot of land are reaped.

### Example 4: Allocating Battery Charging Hardware to Battery Charging Tasks

The provided systems and methods may be used to allocate battery charging hardware for use in various battery charging tasks. Each battery charging task may require a certain amount of power to be delivered in a certain amount of time. Any given piece of battery charging hardware may not be suitable for every battery charging task. Some battery charging hardware, for example, may overcharge certain battery types associated with certain battery charging tasks. The described systems and methods can generate a battery charging hardware allotment that ensures each battery charging task is fulfilled while simultaneously ensuring that the battery charging hardware is used appropriately.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising:
receiving category data associated with a plurality of categories and resource data associated with a plurality of resources, wherein:
the category data indicates, for each category of the plurality of categories, an amount of resources required by the category, and
the resource data indicates, for each resource of the plurality of resources, a ranking of the plurality of categories;
generating, based on the category data and the resource data, values of one or more constraints associated with an objective function configured to characterize, for a given allotment of the plurality of resources to the plurality of categories, an efficiency of the allotment and an alignment of the allotment with the rankings of the plurality of categories; and
generating, using a quantum computing system, based on the objective function and the values of the one or more constraints, resource allotment data, wherein the resource allotment data indicates an allocation of one or more resources of the plurality of resources to one or more categories of the plurality of categories.

2. The method of claim 1, wherein the quantum computing system is a quantum annealer.

3. The method of claim 2, wherein generating the resource allotment data comprises solving a constrained quadradic model (QCM) problem.

4. The method of claim 1, wherein generating the resource allotment data comprises minimizing an output value of the objective function.

5. The method of claim 1, wherein the one or more constraints associated with the objective function comprise constraints indicating a minimum number of resources of the plurality of resources that should be allocated to each category of the plurality of categories.

6. The method of claim 1, wherein the values of the constraints indicating a minimum number of resources of the plurality of resources that should be allocated to each category of the plurality of categories are set based on the amount of resources required by each category of the plurality of categories.

7. The method of claim 1, wherein the one or more constraints associated with the objective function comprise constraints indicating a maximum number of categories of the plurality of categories to which each resource of the plurality of resources should be allocated.

8. The method of claim 1, comprising generating a graphical representation of the allocation of the one or more resources.

9. The method of claim 1, comprising automatically, using a classical computing system, updating one or more databases according to the resource allotment data.

10. The method of claim 1, wherein:
the plurality of categories is a plurality of business units,
the plurality of resources is a plurality of employees, and
the ranking of business units associated with each employee indicates the employee's preference for working in each business unit.

11. The method of claim 10, comprising automatically generating and deploying one or more communicative channels for one or more employee devices based on the resource allotment data.

12. The method of claim 1, wherein:
the plurality of categories is a plurality of computational tasks,
the plurality of resources is a plurality of computational resources, and
the ranking of computational tasks associated with each computational resource indicates an efficiency with which the computational resource could execute each computational task.

13. The method of claim 12, comprising automatically provisioning one or more of the plurality of computational resources based on the resource allotment data.

14. The method of claim 1, wherein:
the plurality of categories is a plurality of land uses,
the plurality of resources is a plurality of land plots, and
the ranking of land uses associated with each land plot indicates a level of approval for using the land plot for each land use.

15. The method of claim 1, comprising validating the allocation of the one or more resources based on the resource allocation data, the amounts of resources required by each category, and the rankings of the plurality of categories associated with each resource.

16. A system comprising:
a classical computing system; and
a quantum computing system,
wherein the system is configured to:
receive, using the classical computing system, category data associated with a plurality of categories and resource data associated with a plurality of resources, wherein:
the category data indicates, for each category of the plurality of categories, an amount of resources required by the category, and
the resource data indicates, for each resource of the plurality of resources, a ranking of the plurality of categories;
generate, using the classical computing system, based on the category data and the resource data, values of one or more constraints associated with an objective function configured to characterize, for a given allotment of the plurality of resources to the plurality of categories, an efficiency of the allotment and an alignment of the allotment with the rankings of the plurality of categories; and
generate, using the quantum computing system, based on the objective function and the values of the one or more constraints, resource allotment data, wherein the resource allotment data indicates an allocation of one or more resources of the plurality of resources to one or more categories of the plurality of categories.

17. The system of claim 16, wherein the quantum computing system is a quantum annealer.

18. The system of claim 17, wherein the quantum computing system generates the resource allotment data by solving a constrained quadratic method (QCM) problem.

19. The system of claim 16, wherein the quantum computing system generates the resource allotment data by minimizing an output value of the objective function.

20. The system of claim 16, wherein the one or more constraints associated with the objective function comprise constraints indicating a minimum number of resources of the plurality of resources that should be allocated to each category of the plurality of categories.

21. The system of claim 20, wherein the values of the constraints indicating a minimum number of resources of the plurality of resources that should be allocated to each category of the plurality of categories are set based on the amount of resources required by each category of the plurality of categories.

22. The system of claim 16, wherein the one or more constraints associated with the objective function comprise constraints indicating a maximum number of categories of the plurality of categories to which each resource of the plurality of resources should be allocated.

23. The system of claim 16, wherein the classical computing system comprises a user interface, and wherein the classical computing system is configured to generate and display, using the user interface, a graphical representation of the allocation of the one or more resources.

24. The system of claim 16, wherein the classical computing system is configured to automatically update one or more databases according to the resource allotment data.

25. The system of claim 16, wherein:
the plurality of categories is a plurality of business units,
the plurality of resources is a plurality of employees, and
the ranking of business units associated with each employee indicates the employee's preference for working in each business unit.

26. The system of claim 16, wherein:
the plurality of categories is a plurality of computational tasks,
the plurality of resources is a plurality of computational resources, and
the ranking of computational tasks associated with each computational resource indicates an efficiency with which the computational resource could execute each computational task.

27. The system of claim 16, wherein:
the plurality of categories is a plurality of land uses,
the plurality of resources is a plurality of land plots, and
the ranking of land uses associated with each land plot indicates a level of approval for using the land plot for each land use.

28. A non-transitory computer readable storage medium storing instructions that, when executed by one or more processors of a classical computing system, cause the classical computing system to:
receive category data associated with a plurality of categories and resource data associated with a plurality of resources, wherein:
the category data indicates, for each category of the plurality of categories, an amount of resources required by the category, and
the resource data indicates, for each resource of the plurality of resources, a ranking of the plurality of categories;
generate, based on the category data and the resource data, values of one or more constraints associated with an objective function configured to characterize, for a given allotment of the plurality of resources to the plurality of categories, an efficiency of the allotment and an alignment of the allotment with the rankings of the plurality of categories; and
receive, from a quantum computing system, resource allotment data generated by the quantum computing system based on the objective function and the values of the one or more constraints, wherein the resource allotment data indicates an allocation of one or more resources of the plurality of resources to one or more categories of the plurality of categories.
